(19) United States
(12) Patent Application Publication
(10) Pub. No.: US 2007/0015656 A1
(43) Pub. Date: Jan. 18, 2007

(54) Fuel Additive and Fuel Treatment Process

(76) Inventors: James M. Valentine, Fairfield, CT (US); Barry N. Sprague, Bethlehem, CT (US)

Correspondence Address: THADDIUS J. CARVIS, 102 NORTH KING STREET, LEESBURG, VA, 20176, US

(21) Appl. No.: 11/458,267

(22) Filed: Jul. 18, 2006

Related U.S. Application Data
(60) Provisional application No. 60/700,198, filed on Jul. 18, 2005.

(51) Int. Cl. B01J 31/00

(52) U.S. Cl. 502/150; 502/325; 502/326; 502/304

(57) ABSTRACT

Disclosed is a fuel additive concentrate having a high flash point which is characterized by a viscosity controlled for dosing in a Bernoulli feed device. The concentrate is high temperature stable and is in a form suitable for on-board dosing of fuel which can provide predictable feed rates from a feed device. It comprises a fuel soluble platinum group metal composition and/or a fuel soluble or dispersible cerium composition and/or a fuel soluble or dispersible iron compound and a high flash aromatic solvent. The solvent and the metal composition or compositions are present in relative amounts to provide a FBC concentrate having a flash point (ASTM D93-85) of greater than 140° F. and, a preferred kinematic viscosity within the range of from 7 to 25 centistokes, as measured by ASTM D445 at 105° F.

### RELATED APPLICATION AND PRIORITY CLAIM

This application is a continuation-in-part of and claims priority to prior U. S. Patent Application No. 60/700,198 filed Jul. 18, 2005.

### BACKGROUND OF THE INVENTION

The invention relates to fuel borne catalysts and their formulation in a manner which facilitates accurate dosage by progressive feed from a metering device to fuel for powering an engine.

The addition of fuel borne catalysts (FBCs) to fuel for operation of engines, especially diesel engines, can provide a number of salutary effects. They can impart an effect in the engine by improving fuel utilization or provide a downstream effect in conjunction with an after treatment device such as diesel particulate filter, a diesel oxidation catalyst and/or a particulate reactor.

Many prior art systems proposed for dosing additives involve complex monitoring electronically and/or mechanically, typically with some form of feedback control and/or a positive feed pump, to achieve a desired concentration of active catalytic metals in the fuel. The provision of systems that require modifications to fuel tanks or to wiring harnesses are often not practical for retrofit applications due to the great variety of trucks being used commercially, even by a single fleet owner.

Other prior art systems require operator monitoring and/or intervention. However, fleet operators need the assurance that an FBC or other additive concentrate is being properly added to the fuel of designated vehicles without requiring a particular operator to perform any task other than his normal operations. Operator monitoring or intervention can be problematic, especially where the same vehicle is used by different operators.

Some devices have been proposed to eliminate operator intervention, but they are often so simple in design that uniform dosage is not feasible. Such systems can result in FBC being wasted or the necessary amount not being present to achieve the objectives of the FBC dosing program.

Current and proposed regulations challenge manufacturers to produce both good fuel economy and reduce emissions. While fuel additives will likely be necessary to achieve the objectives of the regulations, the art has provided no simple device capable of metering an effective FBC into the fuel in a reliable manner with no operator intervention or attention over long periods of time.

Automatic correctly proportioned introduction of fuel additives into the fuel tanks of vehicles on a regular, consistent basis is a challenge to fuel additive suppliers and fleet owners desiring to use them. There is a current need for a safe, economical and effective answer to the problems associated with the regular dispensing additives into the fuel.

### SUMMARY OF THE INVENTION

It is an object of the invention to provide an FBC concentrate useful for self feeding in a pressure gradient device.

It is another object of the invention to provide an FBC concentrate having very high concentrations of catalyst metals in a high flash point mixture which has predictable flow in narrow diameter feed conduits.

It is another object of the invention to provide an FBC concentrate that can provide predictable feed rates from a feed device capable of creating a pressure differential between two points in a fuel supply means, whereby the pressure differential causes the FBC to be metered into the fuel.

These and other objects are achieved by the present invention which provides an FBC concentrate and a method of dosing fuel employing it.

In one aspect the invention provides a high temperature stable fuel borne catalyst concentrate in a form suitable for on-board dosing of fuel which can provide predictable feed rates from a feed device, and comprises: a fuel soluble platinum group metal composition and/or a fuel soluble or dispersible cerium composition and/or a fuel soluble or dispersible iron compound; and a high flash aromatic solvent; wherein the solvent and the metal composition or compositions are present in relative amounts to provide a FBC concentrate having a flash point (ASTM D93-85) of greater than 140° F. Preferably, the kinematic viscosity will be within the range of from 7 to 25 centistokes, as measured by ASTM D445 at 105° F.

Preferred aspects of the invention and exemplary formulations will be described below.

### DETAILED DESCRIPTION OF THE INVENTION

The invention will be described below with reference to a preferred embodiment involving diesel fuel and a particular type of dispenser, but it will be understood by those skilled in the art that the advantages of the invention make it useful in a number of situations, including other types of engines, fuels and dispensers, where high flash points, controlled viscosity and product stability are important.

In a preferred form, the FBC concentrate of the invention is suitable for use in a FBC concentrate feed device utilizing the Bernoulli or other pressure differential/capillary effect, such as those comprised of two chambers separated by a wall comprising a capillary tube and a port connecting the two chambers, whereby fuel flowing into the first of the two chambers flows can flow through the wall into the second of the two chambers and the capillary tube draws FBC concentrate from the first chamber into the second chamber for mixture with the fuel. The fuel flows from a source, such as a fuel tank, through the first chamber and into a fuel feed line supplying the engine in the preferred form. The fuel flow through the first chamber imparts a slight pressure gradient which forces fuel to flow into the FBC concentrate reservoir into the flowing fuel. This forces FBC concentrate up a capillary tube. By controlling the viscosity of the additive and properly selecting the diameter of the tube, the fuel treat rate can be set at a desired level. Raising the additive viscosity or using a smaller diameter tube can reduce the additive flow rate for a given fuel flow rate and therefore, reduce the treat rate. As fuel flow rises in this preferred setup, the pressure differential driving the delivery of FBC concentrate increases, increasing additive flow to compensate for the increased fuel flow. By varying additive viscosity, release rates can be varied without modifying the assembly and produce more precise additive release. It is also desirable to control the additive viscosity within a reasonable range without the introduction of detrimental substances into the fuel (thickeners, etc).

The FBC concentrate is typically mounted on a vehicle, making certain other considerations important: the flash point and other hazard characteristics must be acceptable to this use. Thus, commercial FBC concentrates are not suitable for use in this environment as they are usually formulated without regard for flash point but to obtain the best solubility for the FBC. According to the invention, the flash point is maintained at a temperature of less than 140° F. and preferably is within the range of at least about 145° F. While there is no upper limit on the flash point from a functional standpoint, there is a practical limit due to increase in viscosity for homologous hydrocarbons with increasing flash point, thus the practical upper limit is up to about 225° F. Flash points are determined by ASTM D93-85. It is a distinct advantage of the invention that stable viscosities can be achieved to assure constant, predictable flow rates while avoiding the use of low flash point solvents.

Platinum metal containing fuel FBC concentrates are available commercially as Platinum Plus® brand fuel additives, and have a typical formulation based on 2% 1,5-cyclooctadiene platinum diphenyl (COD Pt diphenyl) in toluene. These additives have both a low flash point and a significant benzene content. Pt COD diphenyl is otherwise an ideal compound for this purpose: it has very high solubility in aromatic solvents of all types, although other forms of Pt could be employed, such as platinum acetyl acetonate (Pt AcAc) is about 10% as soluble in these types of solvents. And, Pt tetramine soaps are also very soluble in these solvents and could be employed. The benzene and toluene in the commercial Platinum Plus® brand fuel additives can preferably be replaced by methods previously described (see, for example United States Patent Application Publication No. 20040172876) with a high flash aromatic solvent to produce a safer product for use in additive reservoirs.

Preferred among the solvents suitable for preparing the FBC concentrates of the invention are aromatic naphthas with flash points in excess of 140° F., and preferably 150° F. and above. These naphtha solvents are highly effective solvents for platinum COD diphenyl and are principally aromatic in content, and preferably will contain at least 95% aromatics to assure a suitable flash point with a viscosity within an effective range for accurate dosing according the present invention. In the preferred form a platinum concentrate is prepared with such a naphtha having a 150° F. flash point and this concentrate is then diluted as necessary with a naphtha having a flash point of 190° F. This will allow the production of a highly active concentrate with a flash point above 145° F. The kinematic viscosity of the preferred FBC concentrates of the invention will be within the range of from about 1 to 30, and preferably from about 7 to 25, centistokes, as measured by ASTM D445 at 105° F.

The process for preparing the FBC concentrates of the invention preferably employs a fuel-borne catalyst, preferably comprising fuel-soluble platinum and/or cerium and/or iron. The cerium or iron are typically dosed in amounts sufficient to provide concentrations in the fuel of from 0.5 to 25 ppm and the platinum from 0.0005 to 2 ppm, with preferred fuel concentrations of cerium and/or iron of from 5 to 10 ppm, e.g., 7.5 ppm, and the platinum from 0.05 to 0.5ppm, e.g., 0.15 ppm. A preferred ratio of cerium and/or iron to platinum is from 1000:1 to 10:1. One narrower range is from 200:1 to 25: 1.

The fuel treated with an FBC of the invention can contain detergent (e.g., 50-300 ppm), lubricity additive (e.g., 25 to about 500 ppm), other additives, and suitable fuel-soluble catalyst metal compositions, e.g., 0.1 - 2 ppm fuel soluble platinum group metal composition, e.g., platinum COD or platinum acetylacetonate and/or 2-20 ppm fuel soluble cerium or iron composition, e.g., cerium, cerium octoate, ferrocene, iron oleate, iron octoate and the like. Dose rate can be varied as effective, e.g., from about 1: 1000 to 1:20,000 or more to provide catalytically active concentrations of platinum and cerium.

A combination of platinum with either iron or cerium at low concentrations in fuels is as effective as much higher concentrations of cerium, iron or other metals without platinum in reducing carbon or soot deposits or emissions. Concentrations of a few ppm metals in combination are as effective as 30-100 ppm of iron and/or cerium used alone. The metal concentration in the fuel achieved by using the FBC concentrate formulations of the invention avoid problems often encountered using traditional levels of cerium or iron, high enough to be factors in causing equipment fouling due to the high ash burden associated with high metal concentrations in the fuel.

The preferred bimetallic and trimetallic platinum and other catalyst metal combinations are compatible with standard additive components for distillate and residual fuels such as pour point reducers, antioxidant, corrosion inhibitors and the like.

Cerium is commercially available in the form of soaps. All of these are suitable as are stable acetylacetonates and dispersions. Among the specific cerium compounds are: cerium III acetylacetonate, cerium III napthenate, and cerium octoate, cerium oleate and other soaps such as stearate, neodecanoate, and octoate (2-ethylhexoate). Many of the cerium compounds are trivalent compounds meeting the formula: Ce (OOCR)₃ wherein R=hydrocarbon, preferably C₂ to C₂₂, and including aliphatic, alicyclic, aryl and alkylaryl. The cerium is preferred at concentrations of 1 to 15 ppm cerium w/v of fuel. Fatty acid containing compounds of this type are known to the art as soaps, e.g., cerium hydroxy oleate propionate complex and cerium octoate. Preferably, the cerium is supplied as cerium octoate, 12 Wt. % Ce (12% metal in ethyl hexanoic acid). Preferred levels are toward the lower end of this range, e.g., less than 8 ppm.

Among the specific iron compounds are: ferrocene, ferric and ferrous acetyl-acetonates, iron soaps like octoate and stearate (commercially available as Fe(III) compounds, usually), iron pentacarbonyl Fe(CO)₅ , iron napthenate, and iron tallate.

Any of the platinum group metal compositions, e.g., 1,5-cyclooctadiene platinum diphenyl (platinum COD, also referred to as “COD-Pt-diphenyl”), described in U.S. Pat. No. 4,891,050 to Bowers, et al., U.S. Pat. No. 5,034,020 to Epperly, et al., and U.S. Pat. No. 5,266,093 to Peter-Hoblyn, et al., can be employed as the platinum source. Other suitable platinum group metal catalyst compositions include commercially-available or easily-synthesized platinum group metal acetylacetonates, platinum group metal dibenzylidene acetonates, and fatty acid soaps of tetramine platinum metal complexes, e.g., tetramine platinum oleate.

For a highly concentrated FBC concentrate to be made, the cerium and platinum concentrates must be inherently stable and mutually compatible. Commercially available cerium octoate concentrates are compatible with aromatic solvents and the Pt COD diphenyl concentrate in high concentrations.

The concentrated additive must also be stable at high and low temperature extremes. The use of an aromatic solvent maintains solubility at low temperatures and the optional incorporation of amine based stabilizers help to insure that the Pt COD diphenyl complex is stable at prolonged temperatures of 50-60° C. These types of materials are found in standard diesel detergents and the incorporation of commercial diesel detergents will provide high temperature stability of the platinum compounds at temperatures up to 80° C. and above. Concentrations of standard diesel detergents of about 5% and less have been demonstrated to be effective. Unstabilized Pt COD diphenyl can break down slowly at 60-80° C. presumably to metallic platinum presumably by a ligand replacement mechanism. The other forms of Pt can be stabilized similarly.

Viscosity can be regulated by used of a combination of high flash aromatic solvent and diesel detergent. Depending on the viscosity of the detergent used, viscosity can be varied over a wide range. Commercial diesel detergents found to be useful in providing the dual benefits described above include Lubrizol 9570A, Chevron ODA 78012 and Allegheny petroleum DDA 1210. There is no reason to believe that this list is exhaustive. By selection of the proper detergent, the viscosity can be substantially varied: use of the thin Lubrizol detergent listed below can result in additive concentrates with a viscosity of about 1- 20 centistokes at 105° F. (typical engine temperature). Among preferred detergents are those such as the noted Allegheny petroleum DDA 1210 formulated from 65 to 80% polyolefin amide alkaline amines in petroleum distillates, and equivalents, and are characterized by densities (D4052) of from about 0.91 to 0.94, with viscosities (D1445) generally in the range of from 600 to 850 centistokes and flash points (D93) of at least 140° F. Selection of a substantially more viscous detergent can result in a thicker blend when used in high concentrations, and this has utility in suitable situations.

Thus, in addition to the selection and use of a suitable solvent, preferably an aromatic naphtha as indicated, the proper selection of a detergent and/or other fuel additive can provide the necessary viscosity range to achieve the objectives of the invention. In operation, the process for feeding a fuel borne catalyst into a fuel according to the invention entails providing a concentrate as described and feeding it into a capillary tube in communication with a fuel flow line. The fuel flow line can be comprised of a chamber in a fuel filter, a fuel line itself or other chamber through which fuel flows.

The invention will be better understood when the above description is read in light of the following non-limiting examples, wherein all parts and percentages are given by weight, unless otherwise specifically indicated to the contrary.

### EXAMPLE 1

This example describes the preparation of fuel borne catalyst concentrates of three different viscosities to permit selection of one with a viscosity appropriate for a predetermined dosing rate into the fuel of an engine. The three samples below each provide 7.5 ppm Ce and 0.15 ppm Pt at 1:11,000 (v:v) with variable viscosities (therefore, release rates) as listed in the table below.

| | Amount (gr./liter) | | |
|---|---|---|---|
| | Lower | | |
| Component | viscosity | Mid viscosity | High viscosity |
| Platinum Concentrate, | 141.1 | 141.1 | 141.1 |
| 1 Wt. % Pt | | | |
| (2.2% Pt COD diphenyl | | | |
| in Sol 0150¹) | | | |
| Cerium Octoate, | 581.2 | 581.2 | 581.2 |
| 12 Wt. % Ce | | | |
| (12% metal in | | | |
| ethyl hexanoic acid) | | | |
| Sol 0190² | 220 | 155 | 0 |
| Lz 9570A³ | 50 | 106 | 261 |
| | Values | | |
| | Lower | | |
| Property | viscosity | Mid viscosity | High viscosity |
| Kinematic viscosity, | 8.06 | 9.16 | 17.17 |
| centistokes⁴ | | | |
| Heat Stability 60° C. | — | OK | OK |
| for 30days | | | |

¹Aromatic naphtha, flash point 150° F., available as SOL - 0150 from Octel Starreon LLC
²Aromatic naphtha, flash point 190° F., available as SOL - 0190 from Octel Starreon LLC
³Lubrizol diesel detergent
⁴ASTM D445 at 105° F.

The feed rate with a specified feed tube can be determined by calculation once a test FBC concentrate is tested and the flow rate from a capillary tube of known diameter is determined. Given this standard, the flow rate can then be determined knowing that tube diameter increases proportionally with FBC viscosity.

### EXAMPLES 2-9

The following examples 2 through 9 provide fuel additive compositions for dosing into diesel fuel at the indicated dosing ratios to provide platinum and cerium in the fuel at ratios of 0.15/7.5 parts per million, measured in grams per liter of fuel. The following key describes the materials used in Examples 2 through 9.

| | | |
|---|---|---|
| Pt Conc | 2.3% COD Pt diphenyl in Aromatic Naphtha* | |
| Pt acac | 0.4% wt Pt Acetylacetonate (Pt acac)2 in | |
| | Aromatic naphtha* | |
| Ce Conc 1 | 50% solution of Ce trioctoate in 2-ethyl | higher |
| | hexanoic acid | viscosity |
| Ce Conc 2 | 70% solution of cerium hydroxy propionate | lower |
| | oleate complexes in mineral spirits | viscosity |
| 9570A | Lubrizol 9570A, a diesel detergent - Lubrizol | lower |
| | Corp | viscosity |
| ODA78012 | Oronite ODA78012, a diesel detergent Chevron | higher |
| | | viscosity |
| A150 | Aromatic Naptha, flash point 150° F. | |

### EXAMPLE 2

The following fuel additive concentrate is prepared from the following materials for dosing in Diesel Fuel at a ratio of concentrate to fuel of 1:13,000.

| | | Viscosity Concentrate |
|---|---|---|
| Ingredient | Amount in Concentrate | at 40° C. (centistokes) |
| Pt Conc | 167 | 8.11 |
| Ce Conc 1 | 687 | |
| 9570A | 50 | |
| A150* | Balance to 1 liter | |

### EXAMPLE 3

As an alternative, the Al50 was deleted and the detergent was increased to replace it.

| | | Viscosity Concentrate |
|---|---|---|
| Ingredient | Amount in Concentrate | at 40° C. (centistokes) |
| Pt Conc | 167 | 13.74 |
| Ce Conc 1 | 687 | |
| 9570A | Balance to 1 liter | |

### EXAMPLE 4

As an alternative, a different cerium additive was employed.

| | | Viscosity Concentrate |
|---|---|---|
| Ingredient | Amount in Concentrate | at 40° C. (centistokes) |
| Pt Conc | 167 | 1.37 |
| Ce Conc 2 | 206 | |
| 9570A | 50 | |
| A150* | Balance to 1 liter | |

### EXAMPLE 5

As an alternative, a different detergent than in Example 2 was employed.

| | | Viscosity Concentrate |
|---|---|---|
| Ingredient | Amount in Concentrate | at 40° C. (centistokes) |
| Pt Conc | 167 | 7.39 |
| Ce Conc 1 | 687 | |
| ODA78012 | 20 | |
| A150* | Balance to 1 liter | |

### EXAMPLE 6

As an alternative to Example 5, the A150 was deleted and the detergent was increased to replace it.

| | | Viscosity Concentrate |
|---|---|---|
| Ingredient | Amount in Concentrate | at 40° C. (centistokes) |
| Pt Conc | 167 | 27.59 |
| Ce Conc 1 | 687 | |
| ODA78012 | 20 | |

### EXAMPLE 7

As another alternative, a different detergent than in Example 4 was employed.

| | | Viscosity Concentrate |
|---|---|---|
| Ingredient | Amount in Concentrate | at 40° C. (centistokes) |
| Pt Conc | 167 | 1.3 |
| Ce Conc 2 | 206 | |
| ODA78012 | 50 | |
| A150* | Balance to 1 liter | |

### EXAMPLE 8

As another alternative, a concentrate was prepared for blending with fuel at a ratio of 1:11,000.

| | | Viscosity Concentrate |
|---|---|---|
| Ingredient | Amount in Concentrate | at 40° C. (centistokes) |
| Pt acac | 706 | 1.32 |
| Ce Conc 2 | 174 | |
| ODA78012 | 20 | |
| A150* | Balance to 1 liter | |

### EXAMPLE 9

As an alternative to Example 5, the A150 was deleted and the detergent was increased to replace it.

| | | Viscosity Concentrate |
|---|---|---|
| Ingredient | Amount in Concentrate | at 40° C. (centistokes) |
| Pt acac | 706 | 1.32 |
| Ce Conc 2 | 174 | |
| ODA78012 | Balance to 1 liter | |

The above description is intended to enable the person skilled in the art to practice the invention. It is not intended to detail all of the possible modifications and variations which will become apparent to the skilled worker upon reading the description. It is intended, however, that all such modifications and variations be included within the scope of the invention which is seen in the above description and otherwise defined by the following claims. The claims are meant to cover the indicated elements and steps in any arrangement or sequence which is effective to meet the objectives intended for the invention, unless the context specifically indicates the contrary.

1. A high-temperature stable fuel borne catalyst concentrate in a form suitable for on-board dosing of fuel which can provide predictable feed rates from a feed device, and comprises: a fuel soluble platinum group metal composition and/or a fuel soluble or dispersible cerium composition and/or a fuel soluble or dispersible iron compound; and a high flash aromatic solvent; wherein the solvent and the metal composition or compositions are present in relative amounts to provide a FBC concentrate having a flash point of greater than 140° F.

2. A high-temperature stable fuel borne catalyst according to claim 1, wherein the kinematic viscosity is within the range of from 7 to 25 centistokes, as measured by ASTM D445 at 105° F.

3. A high-temperature stable fuel borne catalyst according to claim 1, which comprises a fuel soluble platinum group metal composition and a cerium composition

4. A high-temperature stable fuel borne catalyst according to claim 1, wherein the platinum group metal composition comprises platinum acetyl acetonate and/or 1,5-cyclooctadiene platinum diphenyl and a cerium composition

5. A process for feeding a fuel borne catalyst into a fuel, comprising: providing a concentrate as in claim 1 and feeding it into a capillary tube in communication with a fuel flow line.
